(19) United States
(12) Patent Application Publication
(10) Pub. No.: US 2015/0244704 A1
(43) Pub. Date: Aug. 27, 2015

(54) TECHNIQUES TO AUTHENTICATE USER REQUESTS INVOLVING MULTIPLE APPLICATIONS

(71) Applicant: NETAPP, INC., Sunnyvale, CA (US)

(72) Inventor: Christopher Morrissey, Apex, NC (US)

(73) Assignee: NETAPP, INC., Sunnyvale, CA (US)

(21) Appl. No.: 14/341,014

(22) Filed: Jul. 25, 2014

Related U.S. Application Data
(60) Provisional application No. 61/945,703, filed on Feb. 27, 2014.

(51) Int. Cl. H04L 29/06

(52) U.S. Cl. CPC H04L 63/0815

(57) ABSTRACT

Techniques to authenticate user requests involving multiple applications are described. An apparatus may comprise a logic circuit, and a user interface component operative on the logic circuit to present to a user content from a primary application, handle user commands directed to the primary application, and verify the user to a secondary application using an identifier value that is generated by the primary application for authenticating the user. In one embodiment, the user interface component submits the identifier value to the secondary application in a request for certain content. After determining whether the identifier value is valid, the secondary application provides the requested content or deny the user's request. Other embodiments are described and claimed.

### RELATED APPLICATION

This application claims the benefit of priority under 35 U.S.C. §119(e) to U.S. Provisional Patent Application No. 61/945,703 titled “Techniques to Authenticate User Requests involving Multiple Applications” filed on Feb. 27, 2014, the entirety of which is hereby incorporated by reference.

### BACKGROUND

Computer users occasionally operate a combination of hardware/software elements to access various application data and/or services. These elements may be arranged into multiple applications operating on one computing device or, alternatively, distributed across a plurality of computing devices. The multiple applications often cooperate by exchanging data and/or performing tasks in support of each other.

### BRIEF DESCRIPTION OF THE DRAWINGS

FIGS. 1A-B illustrate an embodiment of a system to authenticate user requests involving multiple applications.

FIG. 2 illustrates an embodiment of a distributed system for the system of FIG. 1.

FIG. 3 illustrates an embodiment of the system of FIG. 1.

FIG. 4 illustrates an embodiment of a logic flow for the system of FIG. 1.

FIG. 5 illustrates an embodiment of a logic flow for the system of FIG. 1.

FIG. 6 illustrates an embodiment of a logic flow for the system of FIG. 1.

FIG. 7 illustrates a message view of a request for the system of FIG. 1.

FIGS. 8A-B illustrate example primary web pages involving content from multiple applications.

FIG. 9 illustrates an embodiment of computing architecture.

FIG. 10 illustrates an embodiment of communications architecture.

### DETAILED DESCRIPTION

Various embodiments are generally directed to techniques to authenticate user requests for multiple applications, devices or systems when such applications, devices or systems utilize separate authentication mechanisms. Some embodiments are particularly directed to techniques to authenticate user requests when multiple applications, such as a primary application and a secondary application provide, data to a user interface running on a user computing device.

A system capable of managing related but independent applications may implement, for example, Single Sign-On or similar technique as a mechanism for providing a user with access to computing resources after one authenticate process. This avoids the need to perform authentication for each application. Conversely, Single Sign-Off is an authentication mechanism whereby a single action of signing out terminates access to multiple software systems. However, handling the Single Sign-On authentication mechanism between two web servers can be difficult to do in a general way. This is especially true when they are running different applications that do not necessarily handle authentication in the same way. In this case, there is a primary web server providing the overall web user interface and a secondary web server that provides content in frames (e.g., inline frames or “iframes”) of the web user interface. One problem with this arrangement is that the primary web server is using one of several authentication mechanisms. The secondary server could have its own authentication and session management, but that would require the user to log in another time for the frame (e.g., iframe) containing the secondary server content.

In various embodiments, an apparatus may comprise a user interface component operative on the user device and configured to provide the secondary application with data associated with the primary application, enabling the secondary application to verify the user's legitimacy. It is appreciated that the present disclosure applies to any appropriate data, such as an identifier value that is generated by the primary application after authenticating the user interface component. This data can represent the validity of the user interface component's requests for content from the secondary application. Using any number of techniques, the primary application may confirm whether or not the data is valid. If, for example, a user to whom the primary application assigns the data also is the user who originates the user requests, the secondary application executes tasks according to instructions intimated by the user requests. It is appreciated that the present disclosure elaborates with additional details some example tasks. Other embodiments are described and claimed.

Various embodiments are directed to authenticating users who request data and/or computing services from multiple applications implementing separate authentication mechanisms, which some embodiments may authenticate users without using a login mechanism. As a result, the embodiments can improve affordability, scalability, modularity, extendibility, or interoperability for an operator, device or network.

To illustrate an example operation, consider a system comprising two web servers of which one is primary web server to provide content for a primary web server's user interface page being displayed at the user's computing device. Another web server, which may be referred to as a secondary web server, is serving content to be shown in various inline frames (iframes) in the primary web server's page. An iframe generally nests content into a portion (e.g., a box frame) of another document, such as a hypertext markup language (HTML) document. It is appreciated that the present disclosure is not limited to any particular type of frame or frame content. Examples of “content” may include without limitation text, interactive software application, advertisement, audio/video, animation and/or the like. Embodiments are not limited in this context.

After having the user provide login credentials, the primary web server may assign an identifier value. The primary web server may alternatively authenticate the user device's network address and map the identifier to that network address without requiring login credentials. As described herein, the identifier value allows the other web server to independently verify that the user requesting content was previously authenticated by the primary web server.

The user interface component passes the identifier value as a content request parameter to the secondary web server according to one example implementation. The identifier value may correspond to a secure session (e.g., a hypertext transport protocol secure (HTTPS) session) between the primary web server and the user where the primary web server previously authenticated the user. The secondary server uses this identifier value to make a connection back to the primary server through a remote interface (e.g., a representational state transfer (REST)-compliant interface) in order to determine whether the identifier value is valid. This process, for example, authenticates the user to access to the secondary server using the standard session identifier and REST-compliant interfaces of the primary web server, effectively using the session identifier as a Single Sign-On (SSO) token, without involving any Single Sign-On (SSO) infrastructure.

After confirming the user interface component's cotemporaneous primary web server authentication, the secondary web server completes the user's request and provides the requested content knowing that the content is being presented to an authorized user. The user interface component running Internet technology software code (e.g., JavaScript) loads the content from the secondary server into the user interface page's iframes.

With general reference to notations and nomenclature used herein, the detailed descriptions which follow may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

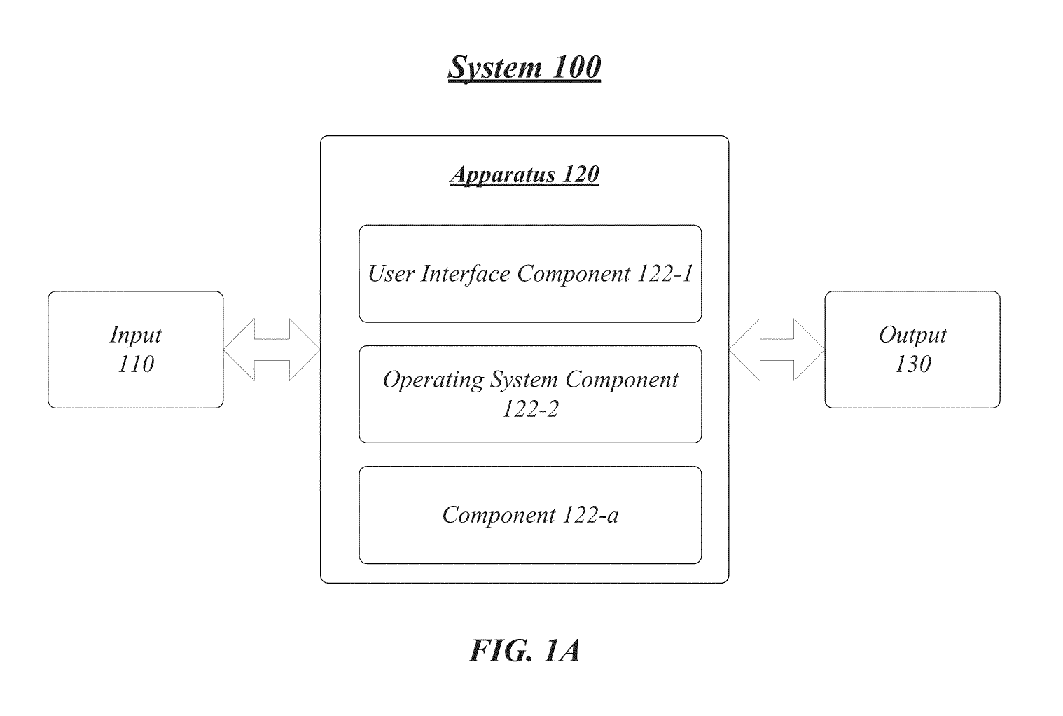

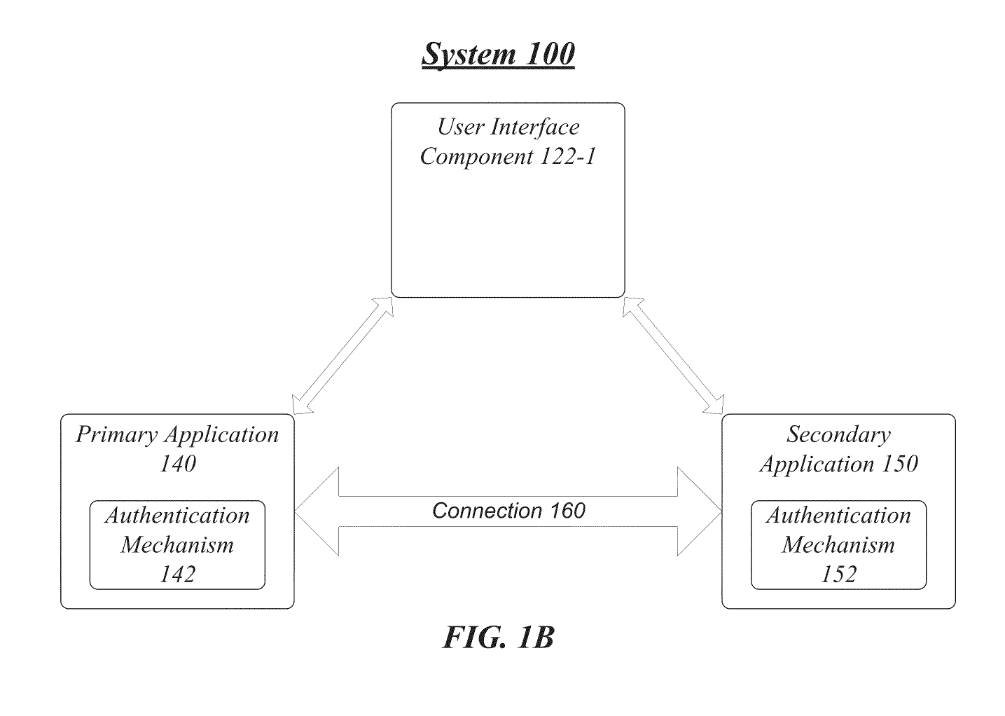

FIG. 1A illustrates a block diagram for a system 100. In one embodiment, the system 100 may comprise a computer-implemented system 100 within which input 110 passes through an apparatus 120 and transforms into output 130. Accordingly, the input 110 and the output 130 refer to input/output activity in general and in some example implementations, for a user interface managed by the apparatus 120. The apparatus 120 generally comprises one or more components 122-a. Although the system 100 shown in FIG. 1 has a limited number of elements in a certain topology, it may be appreciated that the system 100 may include more or less elements in alternate topologies as desired for a given implementation.

It is worthy to note that “a” and “b” and “c” and similar designators as used herein are intended to be variables representing any positive integer. Thus, for example, if an implementation sets a value for a=5, then a complete set of components 122-a may include components 122-1, 122-2, 122-3, 122-4 and 122-5. The embodiments are not limited in this context.

It is appreciated that the system 100 may include any number of hardware/software components that perform some functionality. The system 100 may present content in the form of the user interface to enable interaction with multiple software applications. Some of these applications may handle control directives for this user interface communicated over a network. One of these applications may be herein referred to as a primary application, such as an Internet or web application operative on an operating system component, such as a browser component, or a component running on remote network device, such as a web server. As another example, the primary application may be a virtualization manager application configured to control other virtualization components distributed throughout a computing enterprise.

In one embodiment, the apparatus 120 facilitates operation of the primary application. Via the apparatus 120, the user may initiate various tasks or processes involving, for example, accessing/modifying stored data, provisioning volumes, instantiating virtual machines and/or the like. It is occasionally desirous to invoke functionality provided by another application, such as a secondary application, when performing the above mentioned processes. One example secondary application, sometimes known as a storage application, allocates storage units for use by the primary application.

According to one example, the apparatus 120 comprise a user interface component 122-1 to facilitate interaction with the primary application and the secondary application, for example, to complete tasks initiated by the primary application. While the primary application and the secondary application may relate to each other, the primary application and the secondary application implement different and/or separate authentication mechanisms. The user interface component 122-1 may be generally arranged to facilitate user operation of the secondary application via control elements presented by the apparatus 120. One example implementation of the user interface component 122-1 provides the secondary application with verification of the user's identity by enabling confirmation/validation from the primary application. The user interface component 122-1 may utilize an operating system component 122-2, such as a web browser, to render and present content from the primary application and/or the secondary application. The description herein provides additional details regarding the user interface component 122-1.

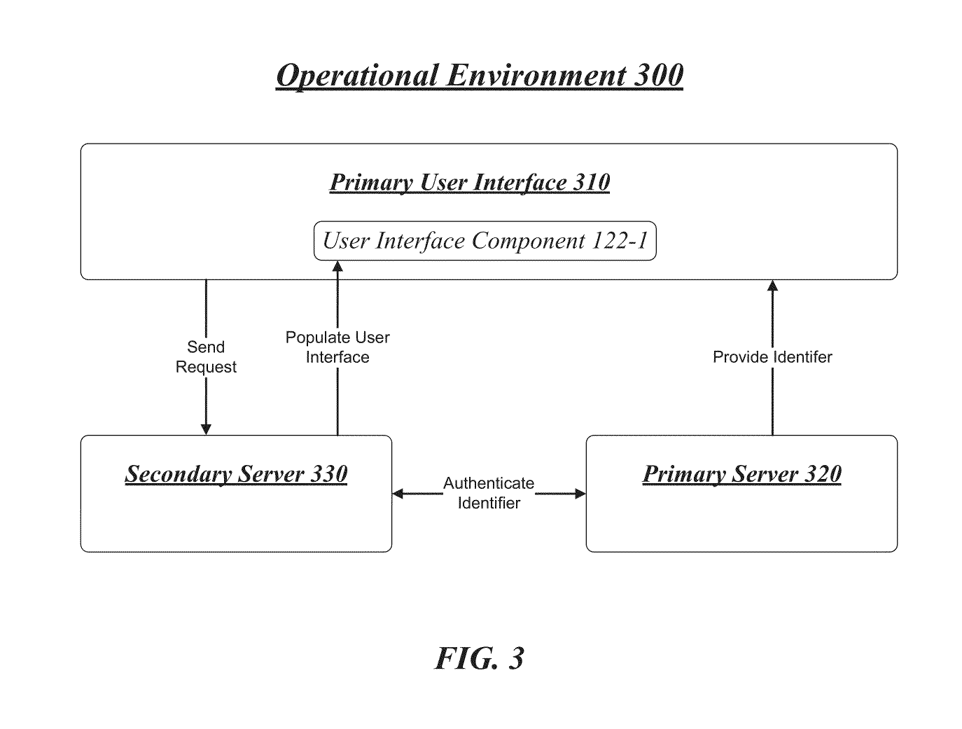

FIG. 1B illustrates a block diagram of the system 100 in which the user interface component 122-1 processes content from a primary application 140 and a secondary application 150. The user interface component 122-1 is an operating system component running on the user device and may comprise a portion of a primary user interface 310 with respect to FIG. 3.

The primary application 140 includes an authentication mechanism 142 that is separate from an authentication mechanism 152 of the secondary application 150. For example, the authentication mechanism 142 implements a Single-Sign-On mechanism for the primary application 140 while the authentication mechanism 152 implements a different mechanism for the secondary application 150. It is appreciated that the primary application 140 and the secondary application 150 may operate the same type of authentication mechanism (e.g., Single-Sign-On) while individually authenticating content requests from users. In any implementation, the secondary application 150 may rely upon a previous authentication by the primary application 140 to authenticate the user interface component 122-1. The secondary application 140 may return content as requested by the user interface component 122-1, without initiating the authentication mechanism. One example user interface component 122-1 includes a web browser component (e.g., a plug-in comprising JavaScript) that loads the requested content into a browser window.

As described herein, the primary application 140 may attempt to verify a user's identity for the secondary application 150 via a connection 160. According to one example, the connection 160 refers to a REST-compliant interface through which the secondary application 150 communicates a message as an HTTPS request or via another REST-compliant protocol. The message may include a session identifier value provided by the user interface component 122-1. As an alternative, the message may simply include the user's identity to which the primary application 140 replies with a valid session identifier for that user. Note, the user interface component 122-1 may be running on a valid user's device or on a malicious device that desires to misappropriate the valid user's identity. The secondary application 150 compares the valid session identifier with the session identifier provided by the user interface component to determine whether the user interface component 122-1 engaged in the valid session with the primary application 150. It is appreciated that other alternative implementations may use other mechanisms to verify the user interface component 122-1.

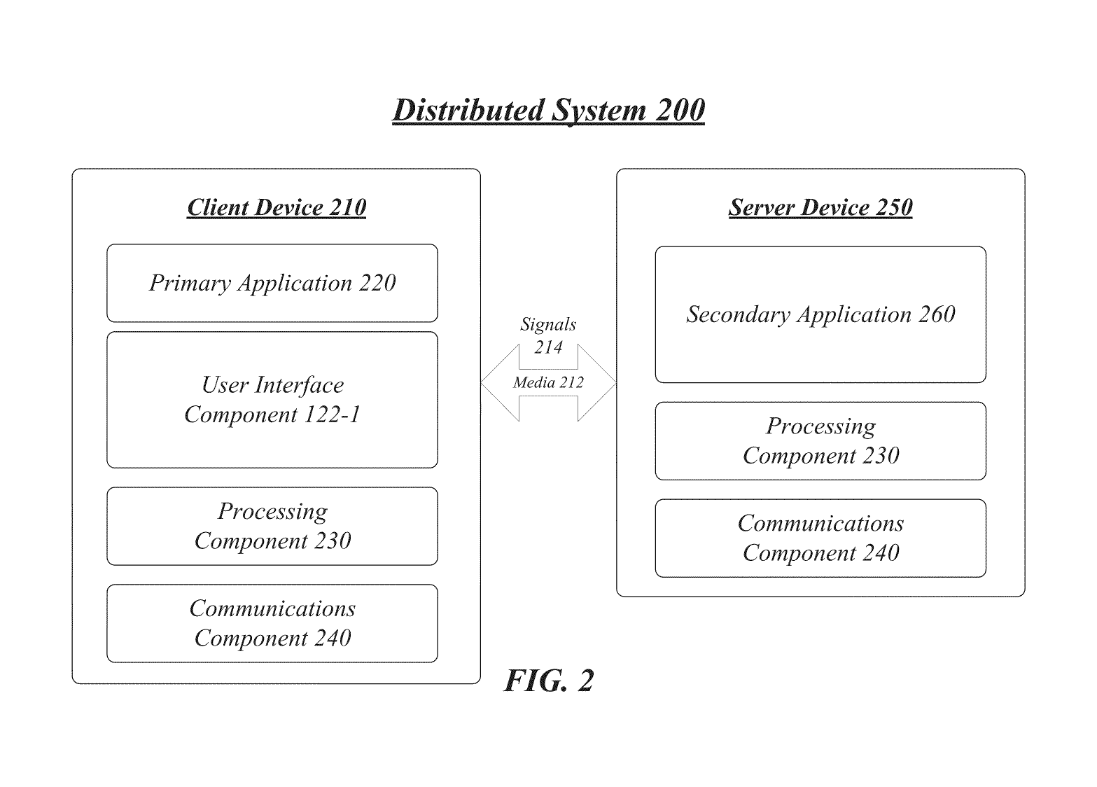

FIG. 2 illustrates a block diagram for a distributed system 200. The distributed system 200 may distribute portions of the structure and/or operations for the system 100 across multiple computing entities. Examples of distributed system 200 may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

The distributed system 200 may comprise a user device 210 and a server device 250. In one example, the devices 210, 250 may communicate over a communications media 212 using communications signals 214 via the communications components 240. The user device 210 may comprise or employ one or more client programs that operate to perform various methodologies in accordance with the described embodiments. In one embodiment, for example, the user device 210 may implement a primary user interface 220 to manage user commands/requests to access various resources and/or to utilize various capabilities of the user device 210.

The user device 210 may execute processing operations or logic for the system 100 using a processing component 230. The processing component 230 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The user device 210 may execute communications operations or logic for the system 100 using communications component 240. The communications component 240 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 240 may include various types of standard communication elements, such as one or more communications interfaces, network interfaces, network interface cards (NIC), radios, wireless transmitters/receivers (transceivers), wired and/or wireless communication media, physical connectors, and so forth. By way of example, and not limitation, communication media include wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

In one embodiment, for example, the user device 210 may implement a primary user interface, such as the user interface component 122-1 of FIG. 1, to handle user commands directed to a primary application 220 and/or to present on a display device various data provided by the primary application 220.

The server device 250 may comprise or employ one or more server programs that operate to perform various methodologies in accordance with the described embodiments. In one example, the server device 250 implements a secondary application 260 to provide content to the user device 210. In one embodiment, the user interface component 122-1, as instructed by the user, may communicate with the server device 250, when appropriate, to complete tasks for the primary application 220, including instances where the secondary application 260 provides certain resources, such as stored data.

Consider the following example operation of the user interface component 122-1. In response to user commands submitted through the user interface component 122-1, the primary application 220 performs various tasks in compliance with the user's directions and/or presents requested data to the user, such as generating rich Internet content (e.g., a web page). The rich Internet content may include control elements for navigating to different web pages, modifying specific data items, operating various application services and/or the like. It is appreciated that the rich Internet content may include content from various productivity applications, such as spreadsheet programs.

When the primary application 220, on behalf of the user, desires data and/or application services from the secondary application 260, the user interface component 122-1 loads any received content into a portion of the rich Internet content, such as an iframe of a web page. Some examples may refer to the iframe as an HTML element, specifically an element representing a nested browsing context. As one example, the user interface component 122-1 and the primary application 220 establish an identifier value, which may be referred to as a primary application session identifier (ID). The user interface component 122-1 may communicate, along with the user commands, the identifier value to the secondary application 260, which may parse and extract the identifier value for authentication and/or other purposes. The data from which the identifier value is extracted may include the identifier value as a parameter, such as a HTTPS header parameter in a HTTPS request.

In order to determine whether the user commands originated from a legitimate primary application session, the secondary application 260 indirectly or directly communicates with the primary application to authenticate the identifier value. For example, the secondary application 260 may request the primary application 220 to confirm generating the identifier value. Once the identifier value is deemed valid, the secondary application 260 may respond to the user interface component 122-1 by providing the requested data and/or services.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

FIG. 3 illustrates an embodiment of an operational environment 300 for the system 100. As shown in FIG. 3, components of the operational environment 300 include a primary user interface 310, a primary server 320 and a secondary server 330. In response to user commands, the primary user interface 310 may invoke the user interface component 122-1, for example, when instructing the secondary server 330 to perform various tasks, such as provisioning virtual machines, running computing services, retrieving stored data, and/or the like. The secondary server 330 may use the primary server 320 to authenticate the user's request for access to that server's applications, data volumes and/or other resources. Using a value known to the primary server 320, such as the session identifier, the secondary server 330 ensures that only authorized users access the secondary server 330. A valid session identifier verifies that the user has previously been authenticated by the primary server 320.

The user interface component 122-1 may include the session identifier in a request. The secondary application on the secondary server 330 may parse and extract the session identifier from the request. The request may be arranged in accordance with a REST-compliant protocol such that the identifier value is included as a parameter value. By way of example, the user interface component 122-1 may generate and communicate a HTTPS request comprising a HTTPS header with a parameter for the session identifier. That HTTPS request may be directed towards a web server coupled to a number of data stores. The secondary application retrieves various data items from one or more of these data stores for presentation to the user.

Since the primary server 320 implements a REST-compliant protocol or, alternatively, another configurable protocol, the web server may determine the session identifier's validity, for example, by retrieving a copy of the session identifier from the primary server and comparing that copy with the session identifier from the primary user interface 310. If there is a mismatch, the primary application running on the primary server 320 is not engaged in computing tasks for the primary user interface 310. One example cause for the mismatch may be a malicious user submitting manipulated requests to the web server. If the session identifiers match, the web server communicates data populating elements of the primary user interface 310. In another embodiment, the REST-compliant protocol includes functionality for authenticating the session identifier. The secondary application communicates a function call and retrieves information indicating whether the session identifier is valid.

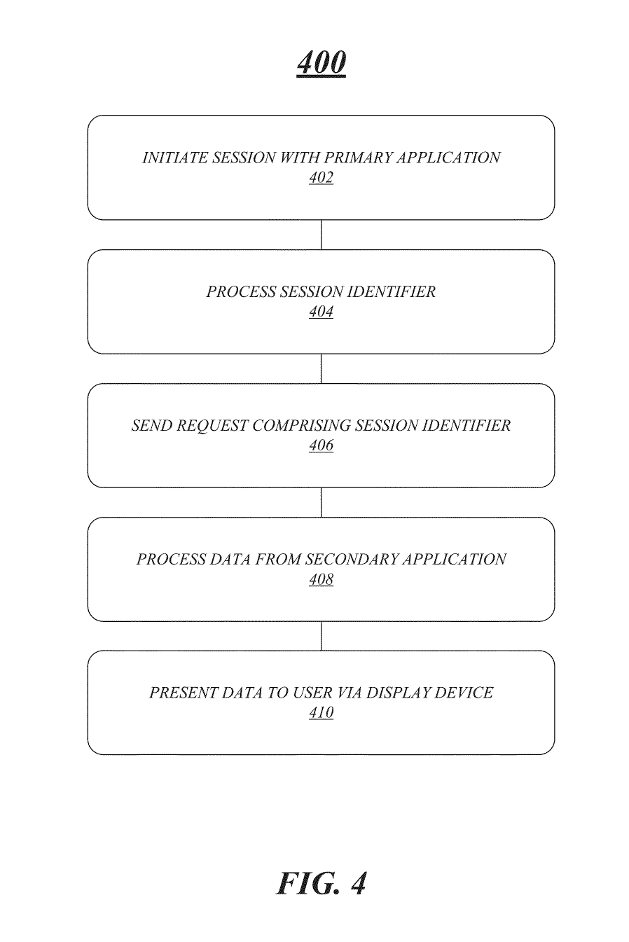

FIG. 4 illustrates one embodiment of a logic flow 400. The logic flow 400 may be representative of some or all of the operations executed by one or more embodiments described herein.

In the illustrated embodiment shown in FIG. 4, the logic flow 400 commences at block 402. For example, the block 402 may be directed to initiating a session (e.g., an HTTPS session) with a primary application, such as the primary application 220 of FIG. 2. During the session, the primary application provides a user interface component running on a logic device with a session identifier.

The logic flow 400 may represent processing of the session identifier user block 404. For example, the user interface component may receive the session identifier from the primary application and use the session identifier to validate data requests to the secondary application.

The logic flow 400 may include sending a request to the secondary application at block 406. For example, the request may include instructions for executing certain tasks and/or retrieving various data. In addition to these instructions, the user interface component may store the session identifier in the request (e.g., as a parameter value) before communication to a server running the secondary application. In turn, the secondary application communicates with the primary application to verify the session identifier's authenticity. Once the session identifier is determined to be authentic, for example, the secondary application executes requested tasks and/or provides the user interface component with requested data.

The logic flow 400 may process data from the secondary application at block 408. For example, the secondary application may configure data volumes for use by different types of applications and respond to the user interface component with addresses/names for these data volumes. As another example, the secondary application may retrieve rich Internet content and return that content to the device running the user interface component. The logic flow 400 may present data to the user at block 410. The embodiments are not limited to this example.

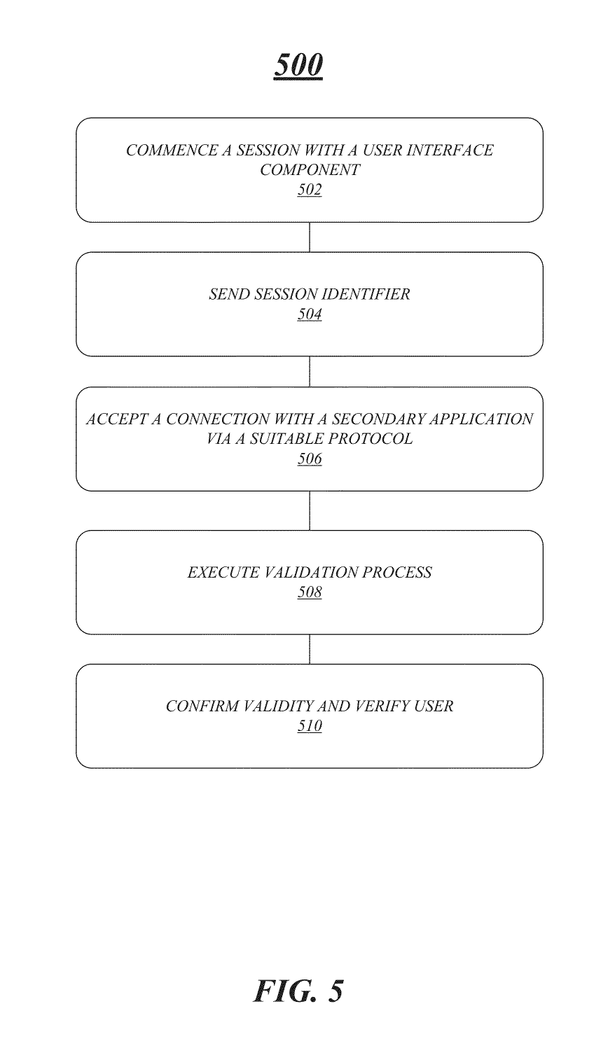

FIG. 5 illustrates one embodiment of a logic flow 500. The logic flow 500 may be representative of some or all of the operations executed by one or more embodiments described herein.

In the illustrated embodiment shown in FIG. 5, the logic flow 500 commences at block 502. For example, the block 502 may commence a session over which data is exchanged with a user interface component. In one embodiment, a primary application running on a primary web server receives a request to initiate a secure session (e.g., a HTTPS session) and to provide content for presentation to a user as a web page. The request may include resource location information for identifying the primary application and/or the requested content on the primary web server. A user interface component (e.g., the user interface component 122-1 of FIG. 1) running on the user's device may request the content to load into portions of the web page.

To illustrate by way of example, the user interface component may provide the user with an interface configured with elements for controlling the primary application. Elements (e.g., data fields) of the user interface may be populated with data retrieved from the primary application. In one embodiment, the primary application completes certain tasks by utilizing a secondary application for data and/or services corresponding to populating user interface elements.

The logic flow 500 may include sending a session identifier at block 504. The session identifier refers to an identifier value configured to verify the user to one or more other applications. By using the session identifier to provide validate of the session, the user interface component may load other content from another application (e.g., a secondary application). The user interface component may submit the session identifier to the other application as a parameter (e.g., a uniform resource locator (URL) parameter) in a HTTP or HTTPS request.

To illustrate an example validation process, the logic flow 500 proceeds to block 506 where the primary application accepts a connection with a secondary application via a suitable protocol. The secondary application may initiate a connection over a REST-compliant protocol through which validity of the session identifier may be verified. In one embodiment, the primary application provides the secondary application with a portal to view various information, including session information, and determine whether the session identifier corresponds to a valid session. In another embodiment, the secondary application invokes functionality that receives as input the session identifier and outputs information confirming or denying the session identifier's validity.

The logic flow 500 may be directed to block 508 to execute a validation process. In general, the block 508 executes instructions to determine whether an identifier value provided by the secondary application is valid. Upon receipt of a validation request for the session identifier, for example, block 510 may confirm validity of the session identifier and verify the user's session with the primary application. The secondary application, in turn, authorizes requested content to be communicated to the user interface component for presentation to the user. The embodiments are not limited to this example.

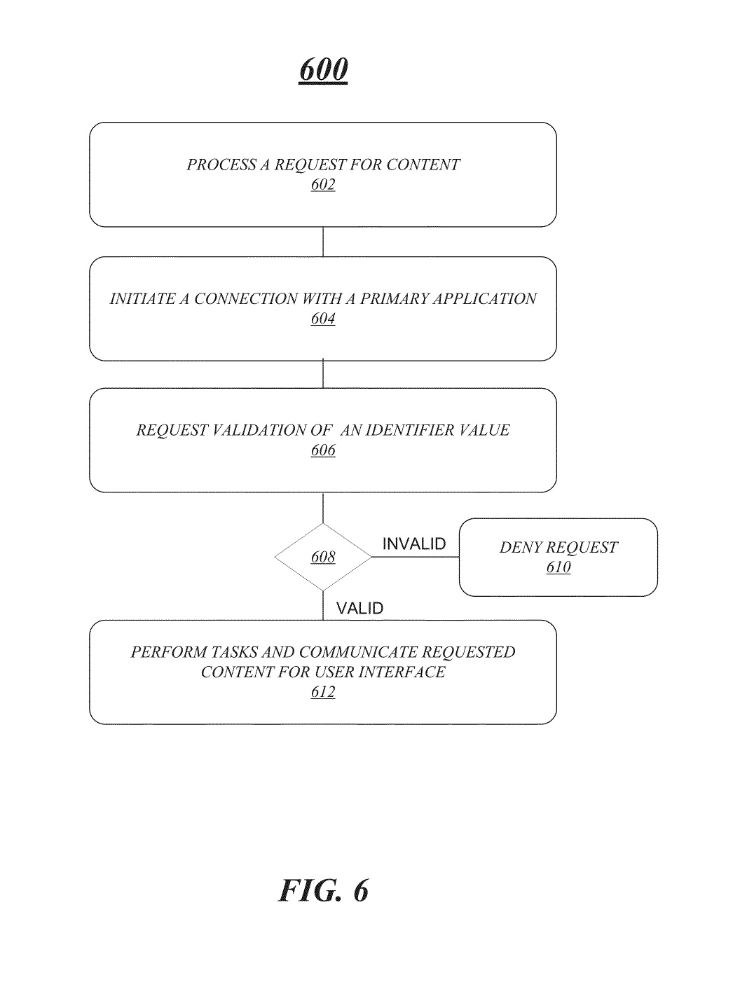

FIG. 6 illustrates one embodiment of a logic flow 600. The logic flow 600 may be representative of some or all of the operations executed by one or more embodiments described herein.

In the illustrated embodiment shown in FIG. 6, the logic flow 600 commences at block 602. For example, the block 602 may be directed to process a user request for data and/or services. As described herein, a user operating a computing device may submit a HTTP or HTTPS request for data and/or services pertaining to tasks that support generation/presentation of a web page. These tasks may be associated with a primary application operative to provide content for the web page. In order to provide certain content, the primary application may utilize one or more other applications for supporting data and/or services. For example, the web page represents a user interface for operating the primary application. The secondary application hosts content to be loaded into the web page being presented to the user. A user interface component running on the computing device submits the user request and generates the requested content to the user in a designated portion of the web page (e.g., as an iframe).

The logic 600 proceeds to block 604 and initiates a connection between the secondary application and the primary application. The request submitted to the secondary application may include an identifier value for verifying the user's association with the primary application. In one embodiment, the secondary application uses the identifier value to determine whether the primary application previously authenticated the user. If the identifier value refers to an authorized user, the secondary application may complete the tasks for the primary application, in some instances, without conducting further verification of the user. Some example embodiments of the connection enable the secondary application to navigate the primary application via representational state transfer based commands. The secondary application may use the identifier value to transition to information describing valid user activity (e.g., valid user sessions).

The logic flow 600 includes a block 606 to request validation of an identifier value provided with the user request. The user interface component may provide the identifier value to authenticate the user's request, for example, by proving the user and the primary application engaged in a valid session. In one embodiment, the secondary application communicates the identifier value over the connection to the primary application and instructs the primary application to authenticate the identifier value. The logic flow 600 may proceed to block 608 to process results related to the validation process and render a determination as to whether the identifier value is valid.

The logic flow 600 may, at block 610, deny the user request if the identifier value is determined to be invalid. If, however, the identifier value corresponds to a valid session between the user and the primary application, the logic flow 600 proceeds to block 612, which performs tasks and communicates content as instructed by the user request. It is appreciated that examples of such tasks may include any computing task, including one or more tasks for populating elements of the user interface with data. As one example, the secondary application may include a virtual machine provisioned by a virtualization manager application to function as a web service for various users. The web service may be used in collaboration with other web services to handle various user commands submitted to the virtualization manager application or another primary application. Alternatively, the secondary application may operate as an independent web service that relies upon the virtualization manager application to properly validate the identifier value prior to initiating any task associated with the user commands. The embodiments are not limited to this example.

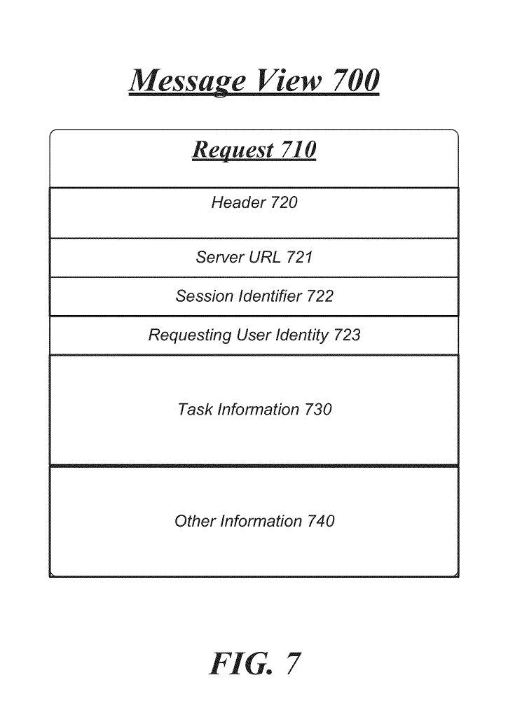

FIG. 7 illustrates a message view 700 of a request 710 for content. A user interface component (e.g., the user interface component 122-1) running on a device may connect to a server and establish a session with an application (e.g., the primary application 220) through which the application determines the device user's identity. The application provides the user interface component with a resource address, an identifier value to represent the session and another identifier value to represent a user (interface) requesting the content. The user interface component may insert the resource location and the identifier values into a header 720 of the request 710 as parameters labeled a server uniform resource locator (URL) 721, a session identifier 722 and a requesting user identity 723, respectively. It is appreciated that in some instances, the request 710 may not use the server URL 721 and only include the session identifier 722 or a requesting user identity as a URL parameter.

The user interface component may communicate the request 710 to a secondary application (e.g., the secondary application 260), which in turn may relay the request 710 or a portion thereof to the primary application for verification prior to providing the user interface component with requested content. As an example, the secondary application may communicate the request 710 as an HTTPS request or via another REST-compliant protocol. As an alternative, the secondary application may request a valid session identifier to independently verify a source of the request 710 by providing the primary application with only the user identity 723. The secondary application may compare the valid session identifier with the session identifier 722 in the request 710 to determine whether a device sending the request engaged in the valid session with the primary application or is a threat of some degree.

Another alternative implementation of the secondary application may extract at least some data from the request 710, and in accordance with a different protocol from the request 710, generate a message requesting verification. The secondary application may communicate the message to the other application via the different protocol. To illustrate by way of example, the secondary application parses the header 720 into individual data fields, selects the primary server URL 721 to identify a destination of the message and inserts the session identifier 722 into a corresponding data field of the message. The destination refers to a primary server operating the primary application. The secondary application uses the different protocol to process a connection with the primary server via the primary server URL 721 and then, route the message through the connection. After examining the message and extracting the session identifier 722, the secondary application returns data to the application indicating whether the session identifier 722 corresponds to a valid session.

The user interface component may add information, such as task information 730, into the request 710 to indicate which content the secondary application is to provide. The task information 730 may identify specific data (e.g., database tables) for the secondary application to return or a set of functions to call. These functions may be implemented by the secondary application or by an application programming interface (API). The task information 730, as another example, includes software code/commands that when executed by the secondary application, cause the server to perform tasks on one or more data volumes or virtual machines. The user interface component may include other information 740 to provide additional options, such as modifiers for the task information 730 or optional run time parameters.

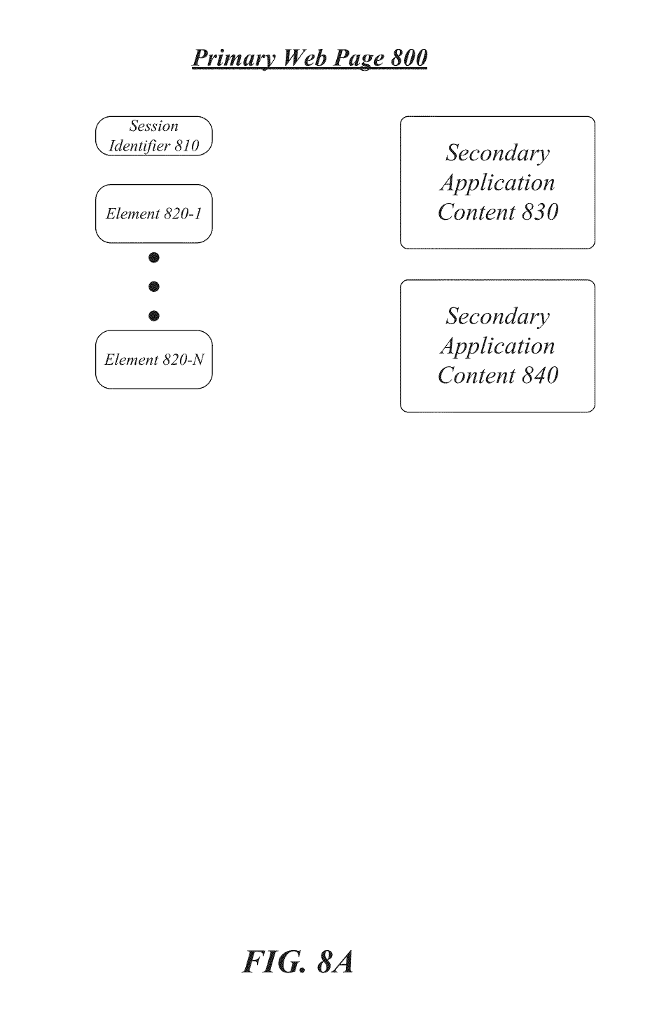

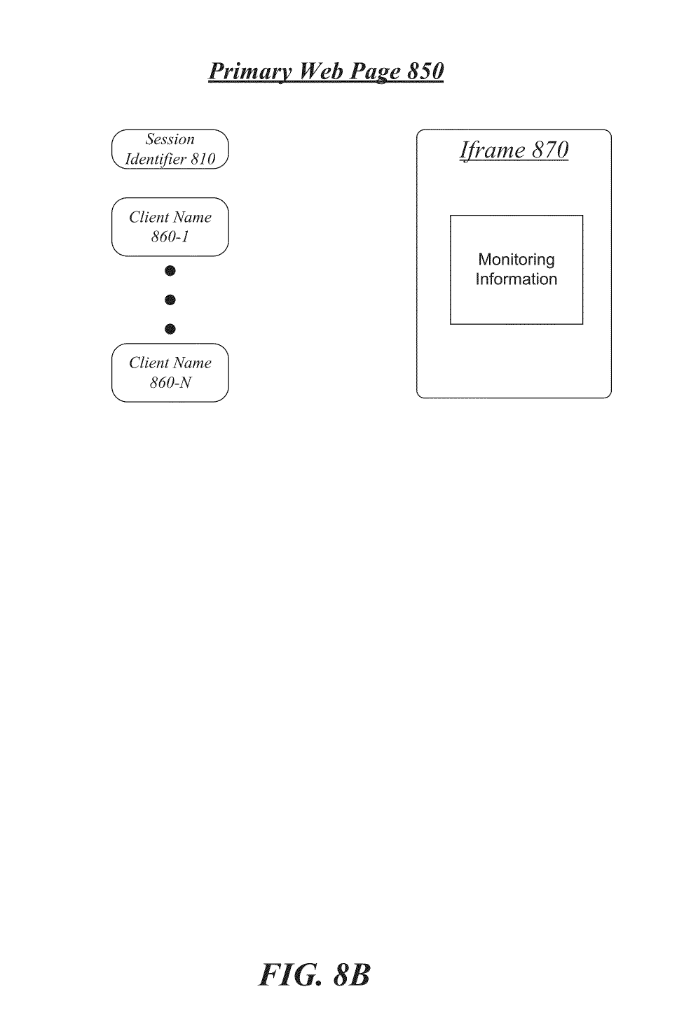

FIG. 8A illustrates an example user interface being represented as a primary web page 800. A user interface component (e.g., the user interface component 122-1) may render the primary web page 800 within a browser window. The primary web page 800 may include a number of elements to display various forms of rich Internet content. As described herein, these elements may include markup language document elements operative to present a user interface using text data, video data, interactive application data, and/or the like. For example, a session identifier 810 may be presented to the user as a text element. As described herein, the session identifier generally refers to a communication session between a user device and a primary web server that is operative to populate at least some of elements 820 with various content.

Using the session identifier 810, the user interface component achieves access to content provided by other web servers operating secondary applications. As described herein, the primary web page 800 may present secondary application content 830 and/or secondary application content 840 within inline frames (iframes). The secondary application content 830 and the secondary application content 840 may be provided by the same secondary application being served by a single server or different secondary applications running on separate web servers.

FIG. 8B illustrates an example primary web page 850 configured to manage cloud computing resources. A virtualization manager application operative to control virtual machine administration within a cloud component environment may assign the session identifier 810 to the user interface component of the user device. The virtualization manager application instantiates a plurality of virtual machines to provide client computers access to the cloud computing resources over a network. As depicted in FIG. 8B, the client computers are associated with HTML elements a client name 860-1 to a client name 860-N. In one implementation, the virtualization manager application may provision each virtual machine with a configuration of computer hardware and/or software sufficient to enable these client computers with computing capabilities (e.g., application and/or data services) and/or computing capacities (e.g., hardware emulation). A virtual machine running within the cloud component environment may operate as a secondary application configured to monitor other instantiated virtual machines. This virtual machine may generate monitoring information for display on the primary web page 850.

To illustrate by way of example, the client name 860-1 may function as a control HTML element to populate iframe 870 with monitoring information for a client computer having the client name 860-1. The monitoring information may relate to computer resource allocation and utilization, such as storage unit size and/or input/output performance. Activating the control element for the client name 860-1 causes the user interface component to send the secondary application a message requesting the monitoring information for the corresponding client computer and including the session identifier 810. As described herein, the secondary application, via a connection with the virtual management application, determines whether the session identifier 810 is valid for the user interface component. Once verified, the user interface component load the monitoring information into the iframe 870 and may render the content into a form viewable on a computer display device.

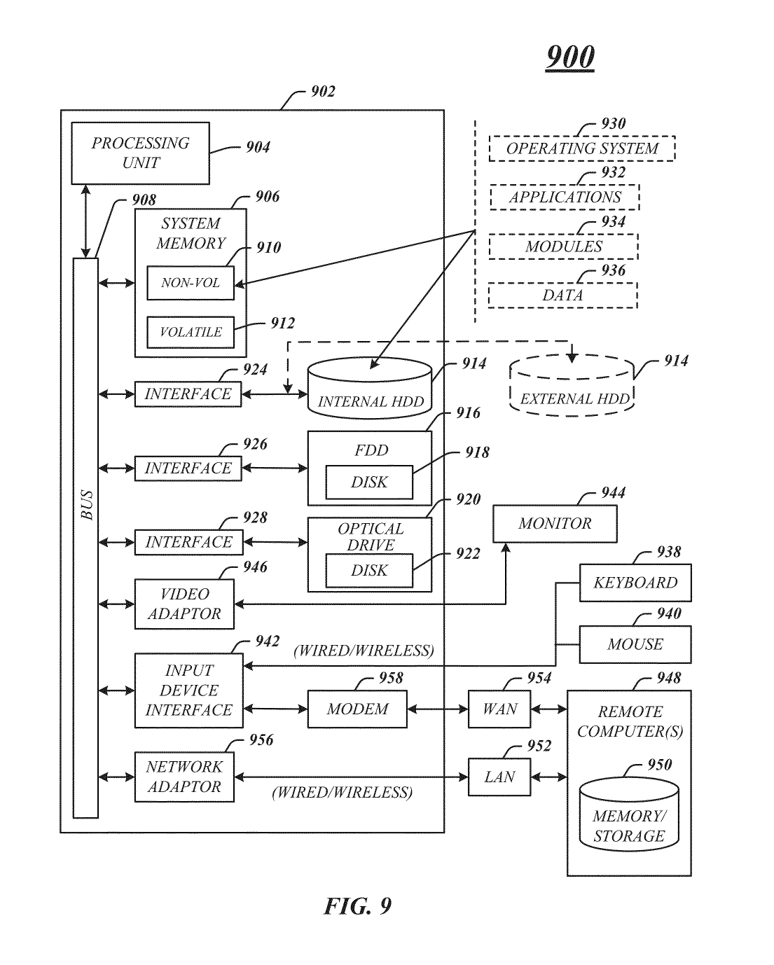

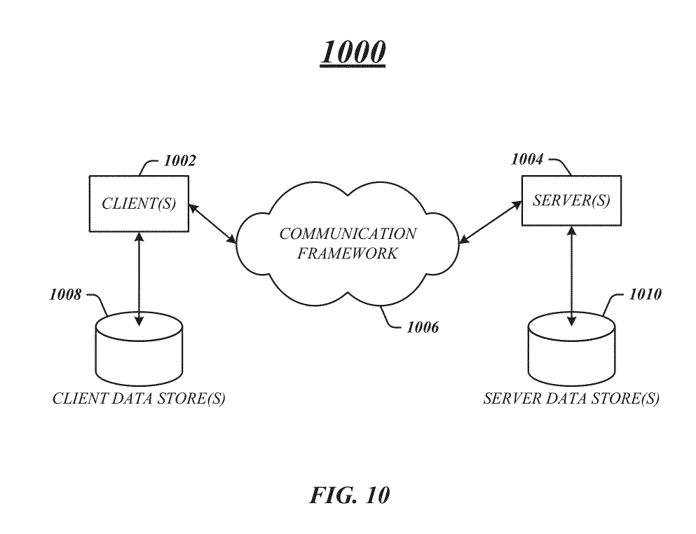

FIG. 9 illustrates an embodiment of an exemplary computing architecture 900 suitable for implementing various embodiments as previously described. In one embodiment, the computing architecture 900 may comprise or be implemented as part of an electronic device. Examples of an electronic device may include those described with reference to FIG. 2, among others. The embodiments are not limited in this context.

As used in this application, the terms “system” and “component” are intended to refer to a computer-related entity, either hardware, a combination of hardware and software, software, or software in execution, examples of which are provided by the exemplary computing architecture 900. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 900 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 900.

As shown in FIG. 8, the computing architecture 900 comprises a processing unit 904, a system memory 906 and a system bus 908. The processing unit 904 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 904.

The system bus 908 provides an interface for system components including, but not limited to, the system memory 906 to the processing unit 904. The system bus 908 can be any of several types of bus structure that may further interconnect to a memory bus (with or without a memory controller), a peripheral bus, and a local bus using any of a variety of commercially available bus architectures. Interface adapters may connect to the system bus 908 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 900 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 906 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 8, the system memory 906 can include non-volatile memory 910 and/or volatile memory 912. A basic input/output system (BIOS) can be stored in the non-volatile memory 910.

The computer 902 may include various types of computer-readable storage media in the form of one or more lower speed memory units, including an internal (or external) hard disk drive (HDD) 914, a magnetic floppy disk drive (FDD) 916 to read from or write to a removable magnetic disk 918, and an optical disk drive 920 to read from or write to a removable optical disk 922 (e.g., a CD-ROM or DVD). The HDD 914, FDD 916 and optical disk drive 920 can be connected to the system bus 908 by a HDD interface 924, an FDD interface 926 and an optical drive interface 928, respectively. The HDD interface 924 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 910, 912, including an operating system 930, one or more application programs 932, other program modules 934, and program data 936. In one embodiment, the one or more application programs 932, other program modules 934, and program data 936 can include, for example, the various applications and/or components of the system 100.

A user can enter commands and information into the computer 902 through one or more wire/wireless input devices, for example, a keyboard 938 and a pointing device, such as a mouse 940. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 904 through an input device interface 942 that is coupled to the system bus 908, but can be connected by other interfaces such as a parallel port, IEEE 1394 serial port, a game port, a USB port, an IR interface, and so forth.

A monitor 944 or other type of display device is also connected to the system bus 908 via an interface, such as a video adaptor 946. The monitor 944 may be internal or external to the computer 902. In addition to the monitor 944, a computer typically includes other peripheral output devices, such as speakers, printers, and so forth.

The computer 902 may operate in a networked environment using logical connections via wire and/or wireless communications to one or more remote computers, such as a remote computer 948. The remote computer 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wire/wireless connectivity to a local area network (LAN) 952 and/or larger networks, for example, a wide area network (WAN) 954. Such LAN and WAN networking environments are commonplace in offices and companies, and facilitate enterprise-wide computer networks, such as intranets, all of which may connect to a global communications network, for example, the Internet.

When used in a LAN networking environment, the computer 902 is connected to the LAN 952 through a wire and/or wireless communication network interface or adaptor 956. The adaptor 956 can facilitate wire and/or wireless communications to the LAN 952, which may also include a wireless access point disposed thereon for communicating with the wireless functionality of the adaptor 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wire and/or wireless device, connects to the system bus 908 via the input device interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with wire and wireless devices or entities using the IEEE 802 family of standards, such as wireless devices operatively disposed in wireless communication (e.g., IEEE 802.5 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.5x (a, b, g, n, etc.) to provide secure, reliable, fast wireless connectivity. A Wi-Fi network can be used to connect computers to each other, to the Internet, and to wire networks (which use IEEE 802.3-related media and functions).

FIG. 9 illustrates a block diagram of an exemplary communications architecture 1000 suitable for implementing various embodiments as previously described. The communications architecture 1000 includes various common communications elements, such as a transmitter, receiver, transceiver, radio, network interface, baseband processor, antenna, amplifiers, filters, power supplies, and so forth. The embodiments, however, are not limited to implementation by the communications architecture 1000.

As shown in FIG. 9, the communications architecture 1000 comprises includes one or more clients 1002 and servers 1004. The clients 1002 may implement the user device 210. The servers 1004 may implement the server device 250. The clients 1002 and the servers 1004 are operatively connected to one or more respective client data stores 1008 and server data stores 910 that can be employed to store information local to the respective clients 1002 and servers 1004, such as cookies and/or associated contextual information.

The clients 1002 and the servers 1004 may communicate information between each other using a communication framework 1006. The communications framework 1006 may implement any well-known communications techniques and protocols. The communications framework 1006 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 1006 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 1002 and the servers 1004. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. An apparatus, comprising:
a logic circuit; and
a user interface component operative on the logic circuit to present content associated with a primary application, receive control directives directed to the primary application, request content from a secondary application, and verify a previous authentication by the primary application to the secondary application.

2. The apparatus of claim 1, wherein the secondary application comprises a separate authentication mechanism from the primary application.

3. The apparatus of claim 1, wherein the user interface component operative to process content corresponding to a session with the primary application and request content from the secondary application using a session identifier that is generated by the primary application.

4. The apparatus of claim 1 further comprising the user interface component operative to load the content from the primary application into a web page and load the content from the secondary application into a portion of the web page.

5. The apparatus of claim 1, wherein the user interface component operative to communicate an identifier value, generated for the user, as a request parameter to a server running the secondary application.

6. The apparatus of claim 1, wherein the user interface component operative to use the content from the primary application and the content from the secondary application to populate elements of a user interface for presentation on a device.

7. The apparatus of claim 1 wherein the user interface component operative to process an identifier value to represent a primary application.

8. The apparatus of claim 1 wherein the user interface component operative to communicate an identifier value that is generated by the primary application after the primary application authenticates the user interface component.

9. A computer-implemented method for verifying a user identity, comprising:
processing a request comprising an identifier value from a server, the identifier value to correspond to a device requesting content from the server,
determining whether the identifier value is valid, and
communicating to the server data to indicate whether the device engaged in a valid session.

10. The method of claim 9, comparing a valid session identifier for the device with the identifier value.

11. The method of claim 9, comprising processing the identifier value as a hypertext transport protocol secure (HTTPS) header parameter in a HTTPS request.

12. The method of claim 9, comprising determining the identifier value corresponds to a primary server authentication.

13. The method of claim 9, comprising communicating the identifier value to the server via a representational state transfer (REST)-compliant interface.

14. An article of manufacture having at least one computer-readable storage medium comprising instructions that when executed, cause a system to:
process user identity data comprised in a request to provide content;
use the user identity data to request a valid session identifier for the user identity; and
based upon the valid session identifier and the user identity data, determine whether to respond to the request with the content.

15. The article of claim 14, comprising instructions that when executed cause the system to compare the valid session identifier to an identifier value embedded in a security token.

16. The article of claim 14, comprising instructions that when executed cause the system to deny the request if the valid session identifier does not match the identifier value.

17. The article of claim 14, comprising instructions that when executed cause the system to communicate the user identity data as a hypertext transport protocol secure (HTTPS) header parameter in a HTTPS request to a primary application.

18. The article of claim 14, comprising instructions that when executed cause the system to communicate frame content after verifying the user identity.

19. The article of claim 14, comprising instructions that when executed cause the system to process a connection with a primary server through a representational state transfer (REST)-compliant protocol, and to request the valid session identifier for the user identity data.

20. The article of claim 14, comprising instructions that when executed cause the system to populate elements of a user interface.
